(19) United States
(12) Patent Application Publication
(10) Pub. No.: US 2024/0346962 A1
(43) Pub. Date: Oct. 17, 2024

(54) MOUNTING SPRING, SYSTEM, KIT AND METHOD FOR MOUNTING A SIGN

(71) Applicant: Lind SignSpring Group, LLC, Mansfield, OH (US)

(72) Inventor: John L. SIEGENTHALER, Mansfield, OH (US)

(21) Appl. No.: 18/339,664

(22) Filed: Jun. 22, 2023

Related U.S. Application Data
(60) Provisional application No. 63/459,309, filed on Apr. 14, 2023.

(51) Int. Cl. G09F 15/00

(52) U.S. Cl. CPC G09F 15/0025; G09F 15/0012

(57) ABSTRACT

A sign mounting system or kit for tautly mounting a flexible material sign to an associated sign structure includes a pair of side molding members each adapted to be mounted to the associated sign structure in a vertical orientation to define vertical sides to which the flexible material sign is secured, a pair of upper molding members adapted to be mounted to the associated sign structure in a horizontal orientation to define an upper side to which the flexible material sign is secured, and a pair of lower molding members adapted to mounted to the associated sign structure in a horizontal orientation to define a lower side to which the flexible material sign is secured. The upper molding members are slidably adjustable so as to be adjustable to specified molding width that matches a sign width of the associated sign structure.

### PRIORITY

This application claims the benefit of U.S. provisional patent application Ser. No. 63/459,309, filed Apr. 14, 2023, which is incorporated by reference in its entirety herein.

### BACKGROUND OF THE INVENTION

Flexible material signs or displays, such as those constructed of vinyl, are increasingly being used in the marketplace. These types of signs are generally lightweight and relatively inexpensive to manufacture. A variety of methods are known for mounting these types of signs to associated sign structures (e.g., billboard structures, building walls, truck trailers, other sign structures, etc.). One known system and method for tautly mounting a sign is disclosed in U.S. Pat. No. 7,168,197, expressly incorporated herein by reference. Another known system and method for tautly mourning a sign is disclosed in U.S. Pat. No. 8,561,330, expressly incorporated herein by reference.

### SUMMARY OF THE INVENTION

According to one aspect, a sign mounting system or kit for tautly mounting a flexible material sign to an associated sign structure includes a pair of side molding members each adapted to be mounted to the associated sign structure in a vertical orientation to define vertical sides to which the flexible material sign is secured, a pair of upper molding members adapted to be mounted to the associated sign structure in a horizontal orientation to define an upper side to which the flexible material sign is secured, and a pair of lower molding members adapted to mounted to the associated sign structure in a horizontal orientation to define a lower side to which the flexible material sign is secured. The upper molding members are slidably adjustable so as to be adjustable to specified molding width that matches a sign width of the associated sign structure.

According to another aspect, a molding is adapted to be mounted to an associated sign structure for tautly mounting a flexible material sign to the associated sign structure. The molding comprises a first molding member and a separate second molding member each adapted to mounted to the associated sign structure in a horizontal orientation. The first and second molding members are slidably adjustable on the associated sign structure so as to be adjustable to a specified molding width that matches a sign width of the associated sign structure. Each of the first molding member and the second molding member includes a plurality of predrilled holes for having mounting springs secured thereto. The first and second molding members together define an upper side or a lower side to which the flexible material sign is secured via the mounting springs.

According to another aspect, a sign mounting method for tautly mounting a flexible material sign includes securing a plurality of sign mounting brackets to a planar face of an associated sign structure and mounting a pair of side molding members in a vertical orientation along vertical sides of the associated sign structure. The side molding members are secured to the sign mounting brackets that are disposed along the vertical sides of the associated sign structure. The method further includes adjustably positioning a pair of upper molding members in a horizontal orientation along an upper side of the associated sign structure so that a longitudinal length of the pair of upper molding members substantially matches a width dimension of the associated sign structure and mounting the pair of upper molding members in the horizontal orientation after said adjustably positioning of the pair of upper molding members. The upper molding members are secured to the sign mounting brackets that are disposed along the upper side of the associated sign structure. The method also includes mounting a pair of lower molding members in a horizontal orientation along a lower side of the associated sign structure. The lower molding members are secured to the sign mounting brackets that are disposed along the lower side of the associated sign structure.

According to a further aspect, a tool for horizontally positioning a molding member on an associated sign structure comprises a mounting part and a handling part connected to the mounting part. The mounting part including a pair of mounting arms, each mounting arm having an upper end portion adapted to be releasably mounted to the molding member and a lower end potion. The handling part includes a pair of spaced apart handling arms coupled to the mounting arms.

### BRIEF DESCRIPTION OF DRAWINGS

FIG. 1 is a front elevation view of a sign mounting system tautly mounting a flexible material sign to an associated sign structure according to an exemplary embodiment.

FIG. 2 is a view of a sign mounting system or kit corresponding to the sign mounting system of FIG. 1.

FIG. 3 is a side view of a mounting spring of the sign mounting system and kit of FIGS. 1 and 2.

FIG. 4 is an end perspective view of one of the molding members of the sign mounting system and kit of FIGS. 1 and 2 showing mounting springs being attached thereto.

FIG. 5 is schematic front elevation view of the associated sign structure, and particularly the planar face thereof, showing locations for the plurality of mounting brackets.

FIG. 5A is a view of a mounting bracket secured to a planar face of the associated sign structure along a side thereof.

FIG. 6A is a view showing a side molding member with mounting springs attached thereto being installed or secured to the side of the associated sign structure.

FIG. 6B is another view showing the side molding member being installed or secured to the side of the associated sign structure.

FIG. 7 is a view of one of a pair of upper molding members showing an overhang bracket attached thereto.

FIG. 8 is still another view showing the upper molding member being installed or secured to the upper side of the associated sign structure.

FIG. 9 is a view of the upper molding member being slidably adjusted on the associated sign structure.

FIG. 10 is a view of one of the mounting springs being secured to the flexible material sign, and particularly of a grasping end of the mounting spring being received through an aperture in the flexible material sign.

### DETAILED DESCRIPTION OF THE INVENTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as “substantially” and “approximately” means a reasonable amount of deviation of the modified word is contemplated such that the end result is not significantly changed.

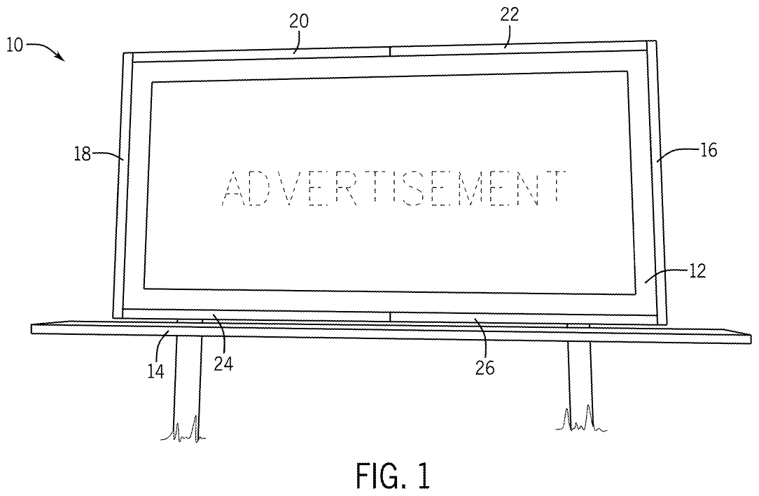

With reference now to the drawings, wherein like numerals refer to like parts throughout the several views, FIG. 1 shows a sign mounting system or kit 10 for tautly mounting a flexible material sign 12 to an associated sign structure 14. The sign 12 can be of any known construction, such as from polyethylene, vinyl, etc. The sign structure 14 can be any structure to which a flexible material sign is to be mounted. For example, the sign structure can be a free standing billboard structure as shown in FIG. 1.

The sign mounting system 10 includes a pair of side molding members 16, 18 each adapted to the mounted to the sign structure 14 in a vertical orientation to define vertical sides to which the flexible material sign 12 is secured. The sign mounting system 10 further includes at least one upper molding member (for example, a pair of upper molding members 20, 22) and at least one lower molding member (for example, a pair of lower molding members 24, 26). The upper molding members 20, 22 are adapted to be mounted to the associated sign structure 14 in a horizontal orientation to define an upper side to which the flexible material sign 12 is secured. The lower molding members 24, 26 are adapted to be mounted to the sign structure 14 in a horizontal orientation to define a lower side to which the flexible material sign 12 is secured. As will be described in more detail below, the upper molding members 20, 22 are slidably adjustable (e.g., relative to the sign structure 14 and/or relative to one another) so as to be adjustable to a specified molding width that matches a sign width of the associated sign structure 14. The molding width can be a longitudinal extent of the upper molding members 20, 22. The lower molding members can likewise be slidably adjustable so as to be adjustable to a specified molding width that matches the sign width of the sign structure 14. It should be appreciated that the molding members 22 and 24 can be of identical construction, and the molding members 16 and 18 can be of identical construction.

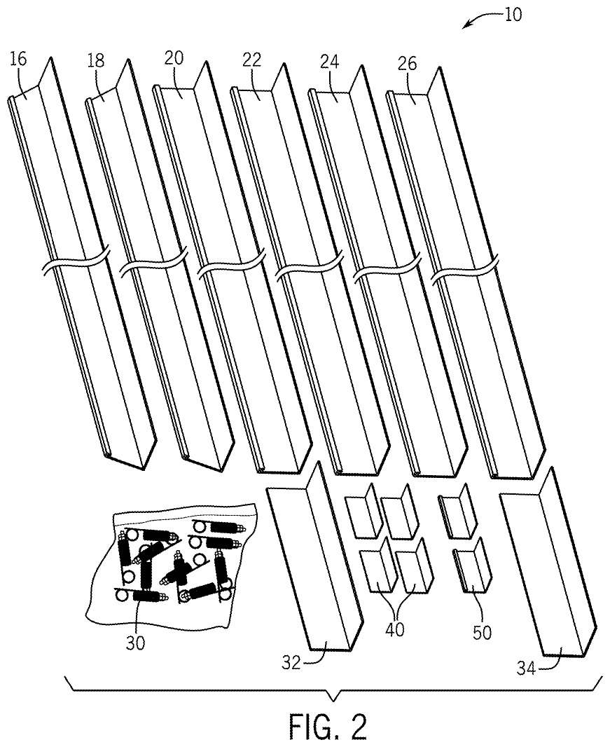

With additional reference to FIG. 2, the sign mounting system of kit 10 is shown in a disassembled state. In one embodiment, the sign mounting system or kit 10 can be packaged with the components shown in FIG. 2 and shipped to a customer so that the customer can install or have installed the flexible material sign 12 of the customer's choice on a sign structure 14 as chosen by the customer. As shown in FIG. 2, the system or kit 10 can additionally include a plurality of mounting springs 30. More particularly, the plurality of mounting springs 30 can be provided as part of the sign mounting system or kit 10 for tautly mounting the flexible material sign 12 to the associated sign structure 14, and particularly to the molding members 16-26, which themselves can be secured to the sign structure 14 as will be described in more detail below.

Additionally, the sign mounting system or kit 10 can include at least one seam cover or sleeve molding member, such as illustrated seam covers 32, 34, for overlaying a seam defined by the upper molding members 20, 22 and/or the lower molding members 24, 26. In one embodiment, the kit 10 includes both seam covers 32, 34 as shown in FIG. 2. The seam cover 32 can be an upper seam cover for overlaying a seam defined by the pair of upper molding members 20, 22. The seam cover 34 can be a lower seam cover for overlaying a seam defined by the pair of lower molding members 24, 26.

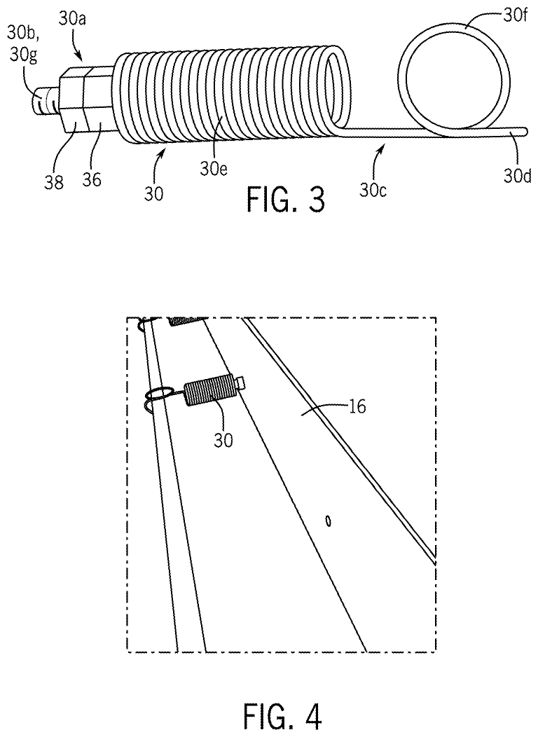

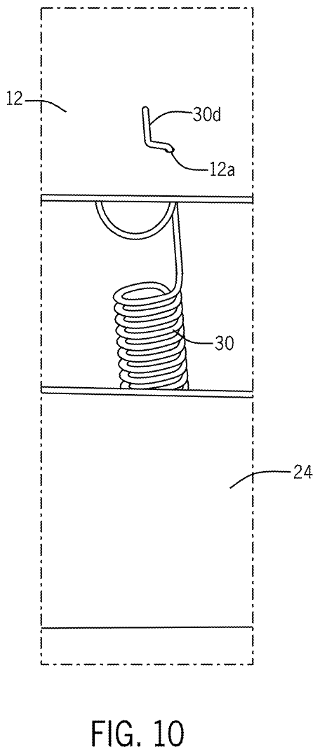

With additional reference to FIG. 3, one of the mounting springs 30 is shown. The mounting spring 30 can include a base portion 30a that can be secured to one of the molding members 16-26. As shown, the base portion 30a can include a threaded region 30b for fastening to one of the molding members 16-26. Additionally, the mounting spring 30 can include a grasping portion 30c including a finger 30d received through an aperture 12a (see FIG. 10). Still further, the mounting spring 30 can include a spring portion 30e disposed between the base portion 30a and the grasping portion 30c to apply a tension to the flexible material sign 12. The mounting spring 30, and particularly the spring portion 30e thereof, can be a coiled spring.

As shown in FIG. 3, the grasping portion 30c on the mounting spring 30 can include a looped portion 30f for applying a tension force on the grasping portion 30c, such as manually via a person's finger, for applying a tension force on the grasping portion 30c relative to the base portion 30a to longitudinally move the grasping portion 30c relative to the base portion 30a by stretching the spring portion 30e. The base portion 30a can include a hooked or looped portion (not shown) adapted to be secured to one of the molding members 16-26 by a head and shaft type fastener 30g, such as a bolt. The hooked or looped portion can be sized to receive a shaft portion of the fastener 30g therethrough and seat against the head portion of the fastener 30g. The mounting spring 30 can additionally include a first threaded member 36 threadedly engaged to the head and shaft fastener 30g to secure the head and shaft fastener 30g to the base portion 30a and a second threaded member 38 for securing the head and shaft fastener 30g and thereby the mounting spring 30 to one of the molding members 16-26. In one embodiment, the threaded members 36, 38 are each nut-type threaded fasteners.

In one embodiment, each of the mounting springs 30 can be one of the springs disclosed in commonly owned U.S. Pat. No. 8,561,330, expressly incorporated herein by reference. With additional reference to FIG. 4, the plurality of mounting springs 30 can have first ends, i.e., base portions 30a, secured to the molding member 16-26 (only molding member 16 shown in FIG. 4) and, as will be described in more detail below, second ends, i.e., grasping portions 30c, secured to the flexible material sign 12 (see FIG. 10). Each of the molding members 16-26 can have a plurality of pre-drilled holes as shown in FIG. 4 for having the mounting springs 30 secured thereto. Each of the molding members 20-26 can be configured to be slidably movable on the sign structure 14 so as to be positionable in accord with a precise width of the sign structure 14.

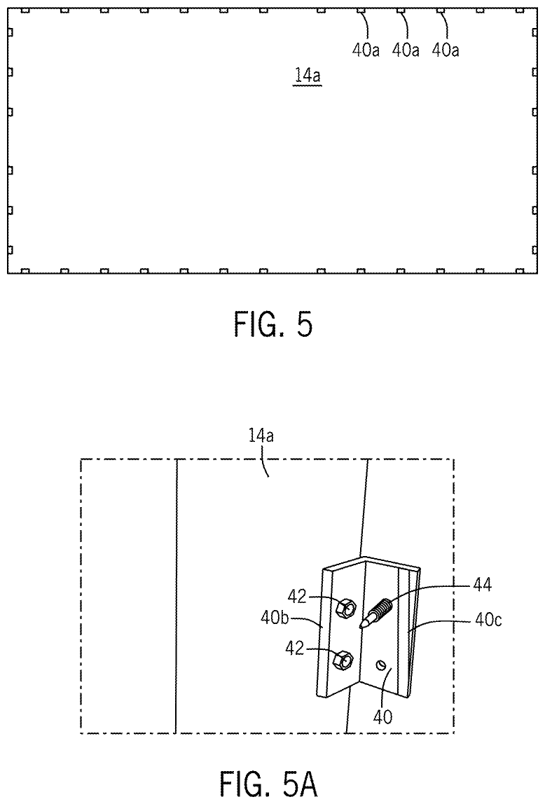

Still further, the sign mounting system or kit 10 can include a plurality of sign mounting brackets 40 (see sign mounting bracket 40 shown in FIG. 5A). With brief reference to FIG. 5, the plurality of sign mounting brackets 40 can be significant in number so that the sign mounting brackets 40 can be mounted at the bracket locations 40a schematically shown in FIG. 5 on a planar face of the sign structure 14. Of course, any number of sign mounting brackets can be used and the exact number is not limited to what is shown and/or described herein. Returning reference to FIG. 5A, each of the plurality of sign mounting brackets 40 can have a first portion 40b for mounting flatly against the planar face 14a of the sign structure 14 and secured thereto via one or more threaded fasteners 42, such as self tapping screws. Each of the plurality of sign mounting brackets 40 can also have a second portion 40c orthogonally oriented relative to the first portion 40b to which the molding members 16-26 can be mounted via a fastener 44 (shown in FIG. 5A), which can be a self tapping screw.

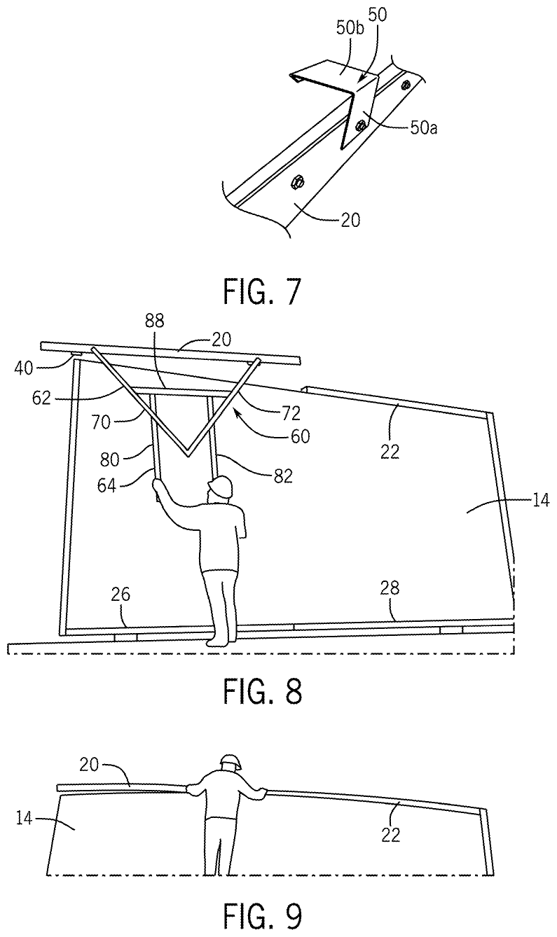

Additionally, the sign mounting system or kit 10 can include one or more overhang brackets 50. More particularly, with reference to FIG. 7, the sign mounting system or kit 10 can include at least one overhang bracket 50 having a first portion 50a for mounting to one of the pair of upper moldings, such as upper molding member 20 (shown in FIG. 7) and a second portion 50b orthogonally oriented relative to the first portion 50a for extending along a rear surface of the sign structure 14.

A sign mounting method for tautly mounting a flexible material sign will now be described in accord with one exemplary embodiment. In particular, the sign mounting method will be described in association with the sign mounting system or kit 10 described hereinabove, though this is not required and the method could be used with other sign mounting systems or kits. In the method, a plurality of sign mounting brackets 40 is secured to the planar face 14a of the associated sign structure 14 as shown in FIG. 5A. In particular, securing the sign mounting brackets 40 can include positioning the sign mounting brackets 40 about the periphery of the planar face 14a of the sign structure 14. This can be, for example, at the locations 40a shown in FIG. 5 about the periphery of the planar face 14a of the sign structure 14.

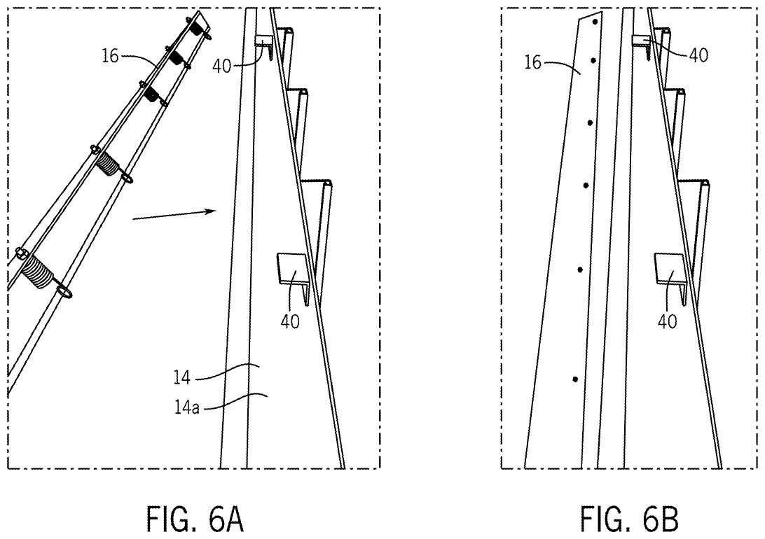

Next, the side molding members 16, 18 can be mounted in respective vertical orientations along vertical sides of the associated sign structure 14. In particular, the side molding members 16, 18 are each secured to the sign mounting brackets 40 that are disposed along the vertical sides of the associated sign structure 14. FIGS. 6A and 6B particularly show one of the side molding members 16 being secured via the brackets 40 to the associated sign structure 14. Optionally, the method can include securing the mounting springs 30 to the molding members 16-28 prior to installation of the molding members 16-26, i.e., prior to mounting the molding members 16-26 to the associated sign structure 14, as shown in FIG. 4.

With reference to FIG. 7, optionally, the overhang brackets 50 can be mounted to the upper molding members 20, 22. In particular, as shown in FIG. 7, at least one overmolding bracket 50 is secured to the upper molding member 20 for assisting and securing the upper molding member 20 against a rear face of the associated sign structure 14. With further reference to FIGS. 8 and 9, the pair of upper molding members 20, 22 are adjustably positioned in a horizontal orientation along the upper side of the associated sign structure 14 so that a longitudinal length of the upper molding members 20, 22 substantially matches a width dimension of the associated sign structure 14. Also, the upper molding members 20, 22 are mounted in the horizontal orientation after being adjustably positioned. The upper molding members 20, 22 can be secured to the sign mounting brackets 40 that are disposed along the upper side of the associated sign structure 14.

A tool 60 can be provided to assist in the positioning of each of the upper molding member 20, 22 along the upper side of the associated sign structure. The tool 60 is configured to be releasably mounted to each of the upper molding members (in FIG. 8 the tool is mounted to the upper molding member 20) thereby allowing a single installer to position each of the upper molding members 20, 22 along the upper side of the associated sign structure, and then remove the tool 60 after the upper molding member is positioned. In the depicted aspect, the tool 60 includes a mounting part 62 connected to a handling part 64. The mounting part 62 includes a pair of mounting arms 70, 72, each having an upper end portion adapted to be mounted to the selective upper molding member. By way of example, the upper end portions of the mounting arms 70, 72 can be notched or similarly adapted to securely received the upper molding member; although, alternative manner for releasably securing the upper molding member 20, 22 are contemplated. The mounting arms 70, 72 can be angled or flared away from one another so that the upper end portions can be mounted nearer to opposite end sections of the upper molding member as compared to a middle section of the upper molding member. By mounting the end portions of the mounting arms 70, 72 nearer to the end sections, the upper molding member 20, 22 can be stablely controlled by the single installer as the upper molding member is positioned along the upper side of the associated sign structure 14. The handling part 64 includes a pair of handling arms 80, 82, which can be directly or indirectly coupled to the mounting arms 70, 72. The handling arms 80, 82 are spaced from one another a predetermined distance to allow for ease of handling of the tool 60. As shown, upper end portions of the handling arms 80, 82 are connected to a support member 88. The support member 88 can also be connected to the mounting arms 70, 72 to further stabilize the mounting arms. Further, as indicated, the mounting arms 70, 72 can be angled or flared away from one another, and in the depicted aspect, the mounting arms 70, 72 are connected to the handling arms 80, 82 and the support member 88, with lower end portions secured to one another. This arrangement can provide additional strength and rigidity to the tool 60.

Similarly, the lower molding members 26, 28 can be adjustably positioned in a horizontal orientation along a lower side of the associated sign structure 14 so that a longitudinal length of the lower molding members 26, 28 substantially matches the width dimension of the associated sign structure 14. Also, the lower molding members 26, 28 can be mounted in the horizontal orientation along the lower side of the associated sign structure 14. The lower molding members 26, 28 can be secured to the sign mounting brackets 40 that are disposed along the lower side of the associated sign structure 14.

As indicated, the upper molding members 20, 22 and the lower molding members 24, 26 are slidably adjustable (e.g., relative to the sign structure 14 and/or relative to one another) so as to be adjustable to a specified molding width that matches a sign width of the associated sign structure 14. To this end, the respective upper molding members 20, 22 and the lower molding members 24, 26 can overlap or can be spaced to define a gap therebetween. The upper seam cover 32 can overlay a seam defined by the overlapping upper molding members 20, 22, or can cover the gap between the upper molding members 20, 22. Similarly, the lower seam cover 34 can overlay a seam defined by the overlapping lower molding members 24, 26, or can cover the gap between the upper molding members 20, 22.

Next, with reference to FIG. 10, the method can include looping the grasping portion 30c of each of the mounting springs 30 through a corresponding aperture 12a in the flexible material sign 12 to thereby secure the flexible material sign 12 to the molding members 16-26.

Still further, the method can optionally include providing a kit, such as kit 10 described hereinabove and/or kit 10 shown in FIG. 2, including at least the molding members 16-26, the mounting springs 30 and the mounting brackets 40. Still further, the method can include installing the seam sleeves or seam covers 32, 34 over the seams defined by the upper molding members 20, 22 and/or the lower molding members 24, 26.

It will be appreciated that various of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A sign mounting system or kit for tautly mounting a flexible material sign to an associated sign structure, comprising:
a pair of side molding members each adapted to be mounted to the associated sign structure in a vertical orientation to define vertical sides to which the flexible material sign is secured;
a pair of upper molding members adapted to be mounted to the associated sign structure in a horizontal orientation to define an upper side to which the flexible material sign is secured; and
a pair of lower molding members adapted to mounted to the associated sign structure in a horizontal orientation to define a lower side to which the flexible material sign is secured,
wherein the upper molding members are slidably adjustable so as to be adjustable to specified molding width that matches a sign width of the associated sign structure.

2. The sign mounting system or kit of claim 1 further including a plurality of mounting springs for tautly mounting the flexible material sign, the plurality of springs having first ends secured to the molding members and second ends secured to the flexible material sign.

3. The sign mounting system or kit of claim 2 wherein each of the springs includes:
a base portion secured to one of the molding members, the base portion including a threaded region for fastening to said one of the molding members;
a grasping portion including a finger received through an aperture of the flexible material sign; and
a spring portion disposed between the base portion and the grasping portion to apply a tension to the flexible material sign,
wherein the grasping portion on each spring includes a looped portion for applying a tension force on the grasping portion relative to the base portion to longitudinally move the grasping portion relative to the base portion by stretching the spring portion,
wherein the base portion includes a hooked or looped portion adapted to be secured to said one of the molding members by a head and shaft type fastener, said hooked or looped portion sized to receive the shaft portion of the fastener therethrough and seat against the head portion of the fastener.

4. The sign mounting system or kit of claim 1 further including:
at least one upper sleeve molding member for overlaying a seam defined by the pair of upper molding members.

5. The sign mounting system or kit of claim 4 further including:
at least one lower sleeve molding member for overlaying a seam defined by the pair of lower molding members.

6. The sign mounting system or kit of claim 1 further including:
a plurality of sign mounting brackets each having a first portion for mounting flat against a planar face of the associated sign structure and being secured thereto via a first fastener, and a second portion orthogonally oriented relative to the first portion to which the molding members can be mounted via a second fastener.

7. The sign mounting system or kit of claim 1 further including:
at least one overhang bracket having a first portion for mounting to one of the pair of upper moldings and a second portion orthogonally oriented relative to the first portion for extending along a rear surface of the associated sign structure.

8. A molding adapted to be mounted to an associated sign structure for tautly mounting a flexible material sign to the associated sign structure, the molding comprising:
a first molding member and a separate second molding member each adapted to mounted to the associated sign structure in a horizontal orientation, wherein the first and second molding members are slidably adjustable on the associated sign structure so as to be adjustable to a specified molding width that matches a sign width of the associated sign structure,
wherein each of the first molding member and the second molding member includes a plurality of predrilled holes for having mounting springs secured thereto, the first and second molding members together defining an upper side or a lower side to which the flexible material sign is secured via the mounting springs.

9. The molding of claim 8 including at least one seam molding member for overlaying a seam defined by the first and second molding members.

10. The molding of claim 9 where the first and second molding members are first and second upper molding members that define the upper side, and further including:
first and second lower molding members adapted to mounted to the associated sign structure in a horizontal orientation to define a lower side to which the flexible material sign is secured, wherein the first and second lower molding members are slidably adjustable on the associated sign structure so as to be adjustable to the specified molding width that matches the sign width of the associated sign structure.

11. The molding of claim 10, wherein the at least one seam molding member is an at least one upper seam molding member, and further including:
at least one lower sleeve molding member for overlaying a seam defined by the first and second lower molding members.

12. A sign mounting method for tautly mounting a flexible material sign, comprising:
securing a plurality of sign mounting brackets to a planar face of an associated sign structure;
mounting a pair of side molding members in a vertical orientation along vertical sides of the associated sign structure, the side molding members secured to the sign mounting brackets that are disposed along the vertical sides of the associated sign structure;
adjustably positioning a pair of upper molding members in a horizontal orientation along an upper side of the associated sign structure so that a longitudinal length of the pair of upper molding members substantially matches a width dimension of the associated sign structure;
mounting the pair of upper molding members in the horizontal orientation after said adjustably positioning of the pair of upper molding members, the upper molding members secured to the sign mounting brackets that are disposed along the upper side of the associated sign structure; and
mounting a pair of lower molding members in a horizontal orientation along a lower side of the associated sign structure, the lower molding members secured to the sign mounting brackets that are disposed along the lower side of the associated sign structure.

13. The sign mourning method of claim 12 further including adjustably positioning the pair of lower molding members in the horizontal orientation along the lower side of the associated sign structure so that a longitudinal length of the pair of lower molding members substantially matches the width dimension of the associated sign structural prior to mounting the pair of lower molding members.

14. The sign mounting method of claim 12 wherein securing the sign mounting brackets including positioning the sign mounting brackets about a periphery of the planar face of the associated sign structure.

15. The sign mounting method of claim 12 further including securing a plurality of mounting springs to the upper and lower molding members prior to mounting the molding members to the associated sign structure.

16. The sign mounting method of claim 12 further including:
installing at least one overhang bracket on each of the upper molding members, and
installing a seam sleeve cover over a seam defined between the pair of upper molding members.

17. A tool for horizontally positioning a molding member on an associated sign structure, the tool comprising:
a mounting part including a pair of mounting arms, each mounting arm having an upper end portion adapted to be releasably mounted to the molding member and a lower end potion, and
a handling part connected to the mounting part, the handling part includes a pair of spaced apart handling arms coupled to the mounting arms.

18. The tool of claim 17 wherein the mounting arms are angled or flared away from one another so that a spacing between the upper end portions of the mounting arms is greater than a spacing between lower end portions of the mounting arms.

19. The tool of claim 18 wherein the lower end portions of the mounting arms are secured to one another.

20. The tool of claim 17 further including a support member for interconnecting upper end portions of the handling arms, the support member further connected to the mounting arms.
